(19) United States
(12) Patent Application Publication
(10) Pub. No.: US 2011/0078425 A1
(43) Pub. Date: Mar. 31, 2011

(54) BRANCH PREDICTION MECHANISM FOR PREDICTING INDIRECT BRANCH TARGETS

(76) Inventors: Manish K. Shah, Austin, TX (US); Gregory F. Grohoski, Bee Cave, TX (US)

(21) Appl. No.: 12/566,847

(22) Filed: Sep. 25, 2009

(51) Int. Cl. G06F 9/38

(52) U.S. Cl. 712/239; 712/E09.045

(57) ABSTRACT

A multithreaded microprocessor includes an instruction fetch unit that may fetch and maintain a plurality of instructions belonging to one or more threads and one or more execution units that may concurrently execute the one or more threads. The instruction fetch unit includes a target branch prediction unit that may provide a predicted branch target address in response to receiving an instruction fetch address of a current indirect branch instruction. The branch prediction unit includes a primary storage and a control unit. The storage includes a plurality of entries, and each entry may store a predicted branch target address corresponding to a previous indirect branch instruction. The control unit may generate an index value for accessing the storage using a portion of the instruction fetch address of the current indirect branch instruction, and branch direction history information associated with a currently executing thread of the one or more threads.

### BACKGROUND OF THE INVENTION

1. Field of the Invention

This invention relates to microprocessors and, more particularly, to branch prediction mechanisms.

2. Description of the Related Art

Modern superscalar microprocessors achieve high performance by executing multiple instructions in parallel and out-of-program-order. However, branch instructions, which are highly prevalent in programs, can cause pipelined microprocessors to stall because instructions after a branch are not known until the branch instruction is executed. This can result in significant losses in performance.

To improve performance, many microprocessors employ branch prediction techniques to speculatively fetch and execute instructions beyond branches. However, if the branch is mispredicted, then all instructions that were speculatively fetched beyond the branch have to be thrown away, or flushed from the pipeline and new instructions have to be fetched from the correct path. This results in loss of performance and waste of power. Thus, the accuracy of the branch prediction mechanism in predicting the direction and target of the branches can greatly impact the performance of the microprocessor.

One conventional prediction mechanism uses a branch target buffer (BTB) to predict the target of the branches. The BTB caches the most recent target address of a branch, and when the branch instruction is fetched, the instruction fetch unit reads the BTB to form the address of the target instruction. However, for some classes of instructions such as, for example, indirect branches BTB-based prediction can perform poorly. More particularly, indirect branches transfer control to an address stored in a register and the target of an indirect branch can change with every dynamic instance of that branch instruction. In many programming languages such as object oriented C++ and Java, for example, indirect branches occur with high frequency. These languages promote a polymorphic programming style, and they execute an indirect branch for every polymorphic call. Accordingly, the accuracy of the branch prediction mechanism in predicting the target of the indirect branches can greatly impact the performance of such programs, and the microprocessors on which they execute.

### SUMMARY

Various embodiments of a mechanism for predicting indirect branch targets are disclosed. In one embodiment, a multithreaded microprocessor includes an instruction fetch unit that may fetch and maintain a plurality of instructions belonging to one or more threads. The processor also includes one or more execution units that may concurrently execute the one or more threads. The instruction fetch unit includes a target branch prediction unit that may provide a predicted branch target address in response to receiving an instruction fetch address of a current indirect branch instruction. The branch prediction unit includes a primary storage and a control unit. The primary storage includes a plurality of entries, and each entry may store a predicted branch target address corresponding to a previous indirect branch instruction. The control unit may generate an index value for accessing the primary storage using a portion of the instruction fetch address of the current indirect branch instruction, and branch direction history information associated with a currently executing thread of the one or more threads.

In one implementation, the target branch prediction unit may also include a secondary storage. Each entry of the secondary storage may store a predicted branch target address corresponding to another previous indirect branch instruction. The control unit may access the secondary storage by generating a second index using a second portion of the instruction fetch address of the current indirect branch instruction.

### BRIEF DESCRIPTION OF THE DRAWINGS

FIG. 1 is a block diagram of one embodiment of a multithreaded processor.

FIG. 2 is a block diagram of one embodiment of a processor core of the multithreaded processor shown in FIG. 1.

FIG. 3 is a block diagram of one embodiment of the fetch unit including a branch prediction unit of the processor cores of FIG. 1 and FIG. 2.

FIG. 4 is a block diagram of one embodiment of the target branch prediction unit of FIG. 3.

FIG. 5 is a flow diagram depicting operational aspects of the target branch prediction unit of FIG. 3 and FIG. 4.

FIG. 6 is a block diagram of one embodiment of a computer system including the multithreaded processor of FIG. 1

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. It is noted that the word “may” is used throughout this application in a permissive sense (i.e., having the potential to, being able to), not a mandatory sense (i.e., must).

### DETAILED DESCRIPTION

### Overview of Multithreaded Processor Architecture

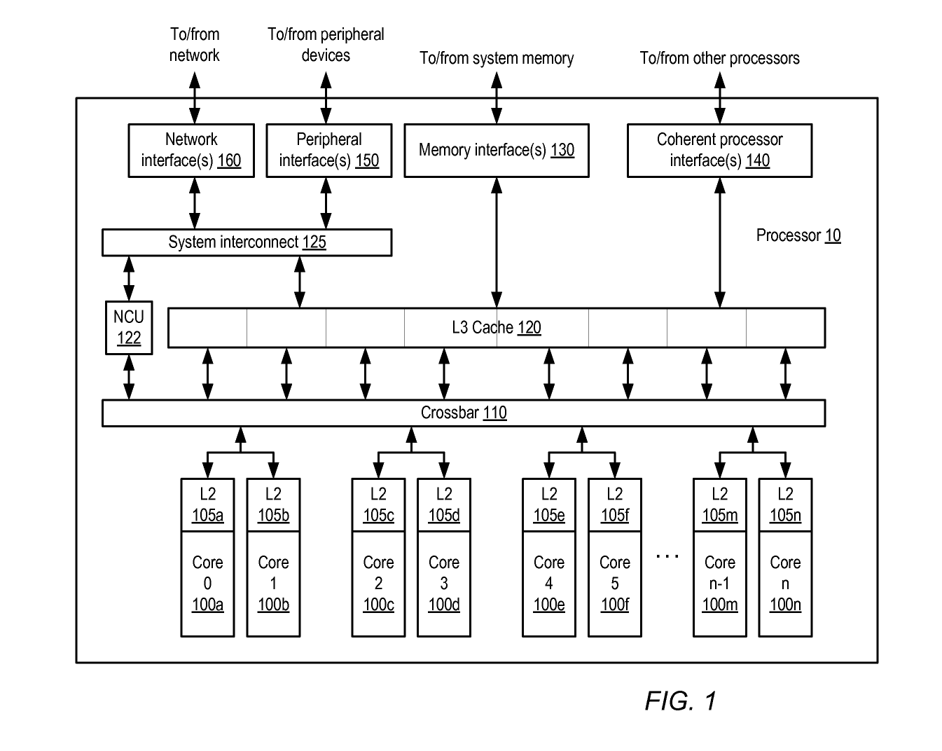

A block diagram illustrating one embodiment of a multithreaded processor 10 is shown in FIG. 1. In the illustrated embodiment, processor 10 includes a number of processor cores 100a-n, which are also designated “core 0” though “core n.” Various embodiments of processor 10 may include varying numbers of cores 100, such as 8, 16, or any other suitable number. Each of cores 100 is coupled to a corresponding L2 cache 105a-n, which in turn couple to L3 cache 120 via a crossbar 110. Cores 100a-n and L2 caches 105a-n may be generically referred to, either collectively or individually, as core(s) 100 and L2 cache(s) 105, respectively.

Via crossbar 110 and L3 cache 120, cores 100 may be coupled to a variety of devices that may be located externally to processor 10. In the illustrated embodiment, one or more memory interface(s) 130 may be configured to couple to one or more banks of system memory (not shown). One or more coherent processor interface(s) 140 may be configured to couple processor 10 to other processors (e.g., in a multiprocessor environment employing multiple units of processor 10). Additionally, system interconnect 125 couples cores 100 to one or more peripheral interface(s) 150 and network interface(s) 160. As described in greater detail below, these interfaces may be configured to couple processor 10 to various peripheral devices and networks.

Cores 100 may be configured to execute instructions and to process data according to a particular instruction set architecture (ISA). In one embodiment, cores 100 may be configured to implement a version of the SPARC® ISA, such as SPARC® V9, UltraSPARC Architecture 2005, UltraSPARC Architecture 2007, or UltraSPARC Architecture 2009, for example. However, in other embodiments it is contemplated that any desired ISA may be employed, such as x86 (32-bit or 64-bit versions), PowerPC® or MIPS®, for example.

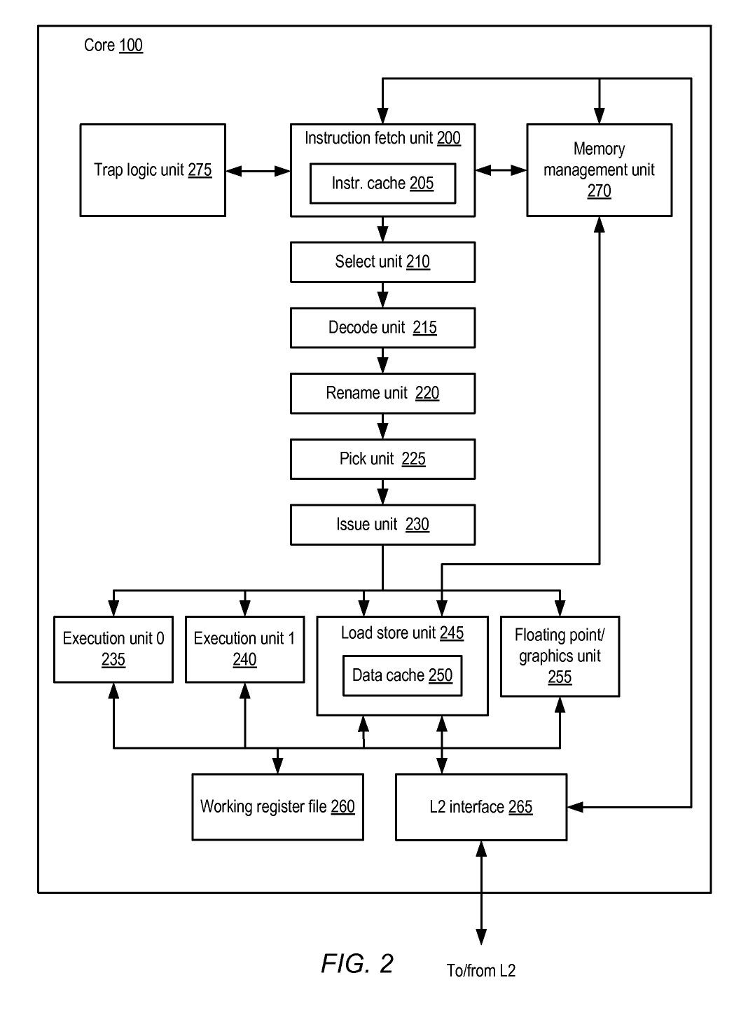

In the illustrated embodiment, each of cores 100 may be configured to operate independently of the others, such that all cores 100 may execute in parallel. Additionally, as described below in conjunction with the description of FIG. 2, in some embodiments, each of cores 100 may be configured to execute multiple threads concurrently, where a given thread may include a set of instructions that may execute independently of instructions from another thread. (For example, an individual software process, such as an application, may consist of one or more threads that may be scheduled for execution by an operating system.) Such a core 100 may also be referred to as a multithreaded (MT) core. In one embodiment, each of cores 100 may be configured to concurrently execute instructions from a variable number of threads, up to eight concurrently-executing threads. In a 16-core implementation, processor 10 could thus concurrently execute up to 128 threads. However, in other embodiments it is contemplated that other numbers of cores 100 may be provided, and that cores 100 may concurrently process different numbers of threads.

Additionally, as described in greater detail below, in some embodiments, each of cores 100 may be configured to execute certain instructions out of program order, which may also be referred to herein as out-of-order execution, or simply OOO. As an example of out-of-order execution, for a particular thread, there may be instructions that are subsequent in program order to a given instruction yet do not depend on the given instruction. If execution of the given instruction is delayed for some reason (e.g., owing to a cache miss), the later instructions may execute before the given instruction completes, which may improve overall performance of the executing thread.

As shown in FIG. 1, in one embodiment, each core 100 may have a dedicated corresponding L2 cache 105. In one embodiment, L2 cache 105 may be configured as a set-associative, writeback cache that is fully inclusive of first-level cache state (e.g., instruction and data caches within core 100). To maintain coherence with first-level caches, embodiments of L2 cache 105 may implement a reverse directory that maintains a virtual copy of the first-level cache tags. L2 cache 105 may implement a coherence protocol (e.g., the MESI protocol) to maintain coherence with other caches within processor 10. In one embodiment, L2 cache 105 may enforce a Total Store Ordering (TSO) model of execution in which all store instructions from the same thread must complete in program order.

In various embodiments, L2 cache 105 may include a variety of structures configured to support cache functionality and performance. For example, L2 cache 105 may include a miss buffer configured to store requests that miss the L2, a fill buffer configured to temporarily store data returning from L3 cache 120, a writeback buffer configured to temporarily store dirty evicted data and snoop copyback data, and/or a snoop buffer configured to store snoop requests received from L3 cache 120. In one embodiment, L2 cache 105 may implement a history-based prefetcher that may attempt to analyze L2 miss behavior and correspondingly generate prefetch requests to L3 cache 120.

Crossbar 110 may be configured to manage data flow between L2 caches 105 and the shared L3 cache 120. In one embodiment, crossbar 110 may include logic (such as multiplexers or a switch fabric, for example) that allows any L2 cache 105 to access any bank of L3 cache 120, and that conversely allows data to be returned from any L3 bank to any L2 cache 105. That is, crossbar 110 may be configured as an M-to-N crossbar that allows for generalized point-to-point communication. However, in other embodiments, other interconnection schemes may be employed between L2 caches 105 and L3 cache 120. For example, a mesh, ring, or other suitable topology may be utilized.

Crossbar 110 may be configured to concurrently process data requests from L2 caches 105 to L3 cache 120 as well as data responses from L3 cache 120 to L2 caches 105. In some embodiments, crossbar 110 may include logic to queue data requests and/or responses, such that requests and responses may not block other activity while waiting for service. Additionally, in one embodiment crossbar 110 may be configured to arbitrate conflicts that may occur when multiple L2 caches 105 attempt to access a single bank of L3 cache 120, or vice versa.

L3 cache 120 may be configured to cache instructions and data for use by cores 100. In the illustrated embodiment, L3 cache 120 may be organized into eight separately addressable banks that may each be independently accessed, such that in the absence of conflicts, each bank may concurrently return data to a respective L2 cache 105. In some embodiments, each individual bank may be implemented using set-associative or direct-mapped techniques. For example, in one embodiment, L3 cache 120 may be an 8 megabyte (MB) cache, where each 1 MB bank is 16-way set associative with a 64-byte line size. L3 cache 120 may be implemented in some embodiments as a writeback cache in which written (dirty) data may not be written to system memory until a corresponding cache line is evicted. However, it is contemplated that in other embodiments, L3 cache 120 may be configured in any suitable fashion. For example, L3 cache 120 may be implemented with more or fewer banks, or in a scheme that does not employ independently-accessible banks; it may employ other bank sizes or cache geometries (e.g., different line sizes or degrees of set associativity); it may employ write-through instead of writeback behavior; and it may or may not allocate on a write miss. Other variations of L3 cache 120 configurations are possible and contemplated.

In some embodiments, L3 cache 120 may implement queues for requests arriving from and results to be sent to crossbar 110. Additionally, in some embodiments L3 cache 120 may implement a fill buffer configured to store fill data arriving from memory interface 130, a writeback buffer configured to store dirty evicted data to be written to memory, and/or a miss buffer configured to store L3 cache accesses that cannot be processed as simple cache hits (e.g., L3 cache misses, cache accesses matching older misses, accesses such as atomic operations that may require multiple cache accesses, etc.). L3 cache 120 may variously be implemented as single-ported or multiported (i.e., capable of processing multiple concurrent read and/or write accesses). In either case, L3 cache 120 may implement arbitration logic to prioritize cache access among various cache read and write requestors.

Not all external accesses from cores 100 necessarily proceed through L3 cache 120. In the illustrated embodiment, non-cacheable unit (NCU) 122 may be configured to process requests from cores 100 for non-cacheable data, such as data from I/O devices as described below with respect to peripheral interface(s) 150 and network interface(s) 160.

Memory interface 130 may be configured to manage the transfer of data between L3 cache 120 and system memory, for example, in response to cache fill requests and data evictions. In some embodiments, multiple instances of memory interface 130 may be implemented, with each instance configured to control a respective bank of system memory. Memory interface 130 may be configured to interface to any suitable type of system memory, such as Fully Buffered Dual Inline Memory Module (FB-DIMM), Double Data Rate or Double Data Rate 2, 3, or 4 Synchronous Dynamic Random Access Memory (DDR/DDR2/DDR3/DDR4 SDRAM), or Rambus® DRAM (RDRAM®), for example. In some embodiments, memory interface 130 may be configured to support interfacing to multiple different types of system memory.

In the illustrated embodiment, processor 10 may also be configured to receive data from sources other than system memory. System interconnect 125 may be configured to provide a central interface for such sources to exchange data with cores 100, L2 caches 105, and/or L3 cache 120. In some embodiments, system interconnect 125 may be configured to coordinate Direct Memory Access (DMA) transfers of data to and from system memory. For example, via memory interface 130, system interconnect 125 may coordinate DMA transfers between system memory and a network device attached via network interface 160, or between system memory and a peripheral device attached via peripheral interface 150.

Processor 10 may be configured for use in a multiprocessor environment with other instances of processor 10 or other compatible processors. In the illustrated embodiment, coherent processor interface(s) 140 may be configured to implement high-bandwidth, direct chip-to-chip communication between different processors in a manner that preserves memory coherence among the various processors (e.g., according to a coherence protocol that governs memory transactions).

Peripheral interface 150 may be configured to coordinate data transfer between processor 10 and one or more peripheral devices. Such peripheral devices may include, for example and without limitation, storage devices (e.g., magnetic or optical media-based storage devices including hard drives, tape drives, CD drives, DVD drives, etc.), display devices (e.g., graphics subsystems), multimedia devices (e.g., audio processing subsystems), or any other suitable type of peripheral device. In one embodiment, peripheral interface 150 may implement one or more instances of a standard peripheral interface. For example, one embodiment of peripheral interface 150 may implement the Peripheral Component Interface Express (PCI Express™ or PCIe) standard according to generation 1.x, 2.0, 3.0, or another suitable variant of that standard, with any suitable number of I/O lanes. However, it is contemplated that any suitable interface standard or combination of standards may be employed. For example, in some embodiments peripheral interface 150 may be configured to implement a version of Universal Serial Bus (USB) protocol or IEEE 1394 (Firewire®) protocol in addition to or instead of PCI Express™.

Network interface 160 may be configured to coordinate data transfer between processor 10 and one or more network devices (e.g., networked computer systems or peripherals) coupled to processor 10 via a network. In one embodiment, network interface 160 may be configured to perform the data processing necessary to implement an Ethernet (IEEE 802.3) networking standard such as Gigabit Ethernet or 10-Gigabit Ethernet, for example. However, it is contemplated that any suitable networking standard may be implemented, including forthcoming standards such as 40-Gigabit Ethernet and 100-Gigabit Ethernet. In some embodiments, network interface 160 may be configured to implement other types of networking protocols, such as Fibre Channel, Fibre Channel over Ethernet (FCoE), Data Center Ethernet, Infiniband, and/or other suitable networking protocols. In some embodiments, network interface 160 may be configured to implement multiple discrete network interface ports.

### Overview of Dynamic Multithreading Processor Core

As mentioned above, in one embodiment each of cores 100 may be configured for multithreaded, out-of-order execution. More specifically, in one embodiment, each of cores 100 may be configured to perform dynamic multithreading. Generally speaking, under dynamic multithreading, the execution resources of cores 100 may be configured to efficiently process varying types of computational workloads that exhibit different performance characteristics and resource requirements. Such workloads may vary across a continuum that emphasizes different combinations of individual-thread and multiple-thread performance.

At one end of the continuum, a computational workload may include a number of independent tasks, where completing the aggregate set of tasks within certain performance criteria (e.g., an overall number of tasks per second) is a more significant factor in system performance than the rate at which any particular task is completed. For example, in certain types of server or transaction processing environments, there may be a high volume of individual client or customer requests (such as web page requests or file system accesses). In this context, individual requests may not be particularly sensitive to processor performance. For example, requests may be I/O-bound rather than processor-bound—completion of an individual request may require I/O accesses (e.g., to relatively slow memory, network, or storage devices) that dominate the overall time required to complete the request, relative to the processor effort involved. Thus, a processor that is capable of concurrently processing many such tasks (e.g., as independently executing threads) may exhibit better performance on such a workload than a processor that emphasizes the performance of only one or a small number of concurrent tasks.

At the other end of the continuum, a computational workload may include individual tasks whose performance is highly processor-sensitive. For example, a task that involves significant mathematical analysis and/or transformation (e.g., cryptography, graphics processing, scientific computing) may be more processor-bound than I/O-bound. Such tasks may benefit from processors that emphasize single-task performance, for example through speculative execution and exploitation of instruction-level parallelism.

Dynamic multithreading represents an attempt to allocate processor resources in a manner that flexibly adapts to workloads that vary along the continuum described above. In one embodiment, cores 100 may be configured to implement fine-grained multithreading, in which each core may select instructions to execute from among a pool of instructions corresponding to multiple threads, such that instructions from different threads may be scheduled to execute adjacently. For example, in a pipelined embodiment of core 100 employing fine-grained multithreading, instructions from different threads may occupy adjacent pipeline stages, such that instructions from several threads may be in various stages of execution during a given core processing cycle. Through the use of fine-grained multithreading, cores 100 may be configured to efficiently process workloads that depend more on concurrent thread processing than individual thread performance.

In one embodiment, cores 100 may also be configured to implement out-of-order processing, speculative execution, register renaming and/or other features that improve the performance of processor-dependent workloads. Moreover, cores 100 may be configured to dynamically allocate a variety of hardware resources among the threads that are actively executing at a given time, such that if fewer threads are executing, each individual thread may be able to take advantage of a greater share of the available hardware resources. This may result in increased individual thread performance when fewer threads are executing, while retaining the flexibility to support workloads that exhibit a greater number of threads that are less processor-dependent in their performance. In various embodiments, the resources of a given core 100 that may be dynamically allocated among a varying number of threads may include branch resources (e.g., branch predictor structures), load/store resources (e.g., load/store buffers and queues), instruction completion resources (e.g., reorder buffer structures and commit logic), instruction issue resources (e.g., instruction selection and scheduling structures), register rename resources (e.g., register mapping tables), and/or memory management unit resources (e.g., translation lookaside buffers, page walk resources).

One embodiment of core 100 that is configured to perform dynamic multithreading is illustrated in FIG. 2. In the illustrated embodiment, core 100 includes an instruction fetch unit (IFU) 200 that includes an instruction cache 205. IFU 200 is coupled to a memory management unit (MMU) 270, L2 interface 265, and trap logic unit (TLU) 275. IFU 200 is additionally coupled to an instruction processing pipeline that begins with a select unit 210 and proceeds in turn through a decode unit 215, a rename unit 220, a pick unit 225, and an issue unit 230. Issue unit 230 is coupled to issue instructions to any of a number of instruction execution resources: an execution unit 0 (EXU0) 235, an execution unit 1 (EXU1) 240, a load store unit (LSU) 245 that includes a data cache 250, and/or a floating point/graphics unit (FGU) 255. These instruction execution resources are coupled to a working register file 260. Additionally, LSU 245 is coupled to L2 interface 265 and MMU 270.

In the following discussion, exemplary embodiments of each of the structures of the illustrated embodiment of core 100 are described. However, it is noted that the illustrated partitioning of resources is merely one example of how core 100 may be implemented. Alternative configurations and variations are possible and contemplated.

Instruction fetch unit 200 may be configured to provide instructions to the rest of core 100 for execution. In one embodiment, IFU 200 may be configured to select a thread to be fetched, fetch instructions from instruction cache 205 for the selected thread and buffer them for downstream processing, request data from L2 cache 105 in response to instruction cache misses, and as described in greater detail below, predict the direction and target of control transfer instructions (e.g., branches). In some embodiments, IFU 200 may include a number of data structures in addition to instruction cache 205, such as an instruction translation lookaside buffer (ITLB), instruction buffers, and/or structures configured to store state that is relevant to thread selection and processing.

In one embodiment, during each execution cycle of core 100, IFU 200 may be configured to select one thread that will enter the IFU processing pipeline. Thread selection may take into account a variety of factors and conditions, some thread-specific and others IFU-specific. For example, certain instruction cache activities (e.g., cache fill), ITLB activities, or diagnostic activities may inhibit thread selection if these activities are occurring during a given execution cycle. Additionally, individual threads may be in specific states of readiness that affect their eligibility for selection. For example, a thread for which there is an outstanding instruction cache miss may not be eligible for selection until the miss is resolved. In some embodiments, those threads that are eligible to participate in thread selection may be divided into groups by priority, for example depending on the state of the thread or of the ability of the IFU pipeline to process the thread. In such embodiments, multiple levels of arbitration may be employed to perform thread selection: selection occurs first by group priority, and then within the selected group according to a suitable arbitration algorithm (e.g., a least-recently-fetched algorithm). However, it is noted that any suitable scheme for thread selection may be employed, including arbitration schemes that are more complex or simpler than those mentioned here.

Once a thread has been selected for fetching by IFU 200, instructions may actually be fetched for the selected thread. To perform the fetch, in one embodiment, IFU 200 may be configured to generate a fetch address to be supplied to instruction cache 205. In various embodiments, the fetch address may be generated as a function of a program counter associated with the selected thread, a predicted branch target address, or an address supplied in some other manner (e.g., through a test or diagnostic mode). The generated fetch address may then be applied to instruction cache 205 to determine whether there is a cache hit.

In some embodiments, accessing instruction cache 205 may include performing fetch address translation (e.g., in the case of a physically indexed and/or tagged cache), accessing a cache tag array, and comparing a retrieved cache tag to a requested tag to determine cache hit status. If there is a cache hit, IFU 200 may store the retrieved instructions within buffers for use by later stages of the instruction pipeline. If there is a cache miss, IFU 200 may coordinate retrieval of the missing cache data from L2 cache 105. In some embodiments, IFU 200 may also be configured to prefetch instructions into instruction cache 205 before the instructions are actually required to be fetched. For example, in the case of a cache miss, IFU 200 may be configured to retrieve the missing data for the requested fetch address as well as addresses that sequentially follow the requested fetch address, on the assumption that the following addresses are likely to be fetched in the near future.

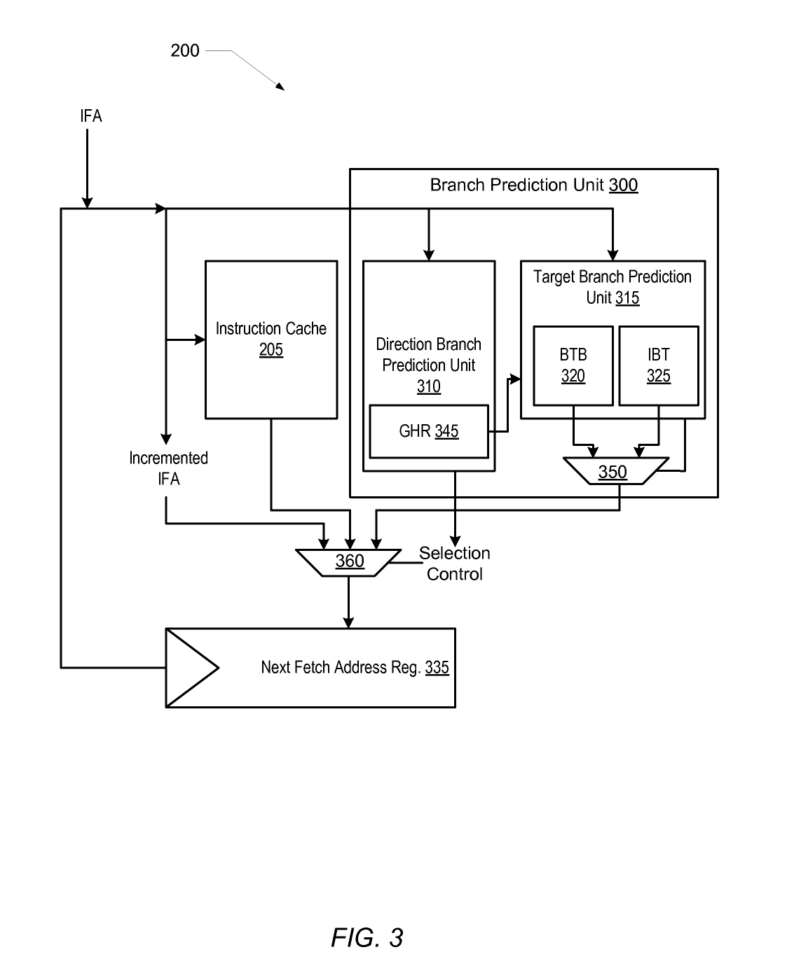

In many ISAs, instruction execution proceeds sequentially according to instruction addresses (e.g., as reflected by one or more program counters). However, control transfer instructions (CTIs) such as branches, call/return instructions, or other types of instructions may cause the transfer of execution from a current fetch address to a nonsequential address. As mentioned above, IFU 200 may be configured to predict the direction and target of CTIs (or, in some embodiments, a subset of the CTIs that are defined for an ISA) in order to reduce the delays incurred by waiting until the effect of a CTI is known with certainty. In one embodiment, IFU 200 may be configured to implement a perception-based dynamic branch predictor to predict the direction of conditional branches, although any suitable type of branch predictor may be employed. In addition, as described further below in conjunction with the descriptions of FIG. 3 through FIG. 5, in one embodiment IFU 200 may implement a target branch predictor.

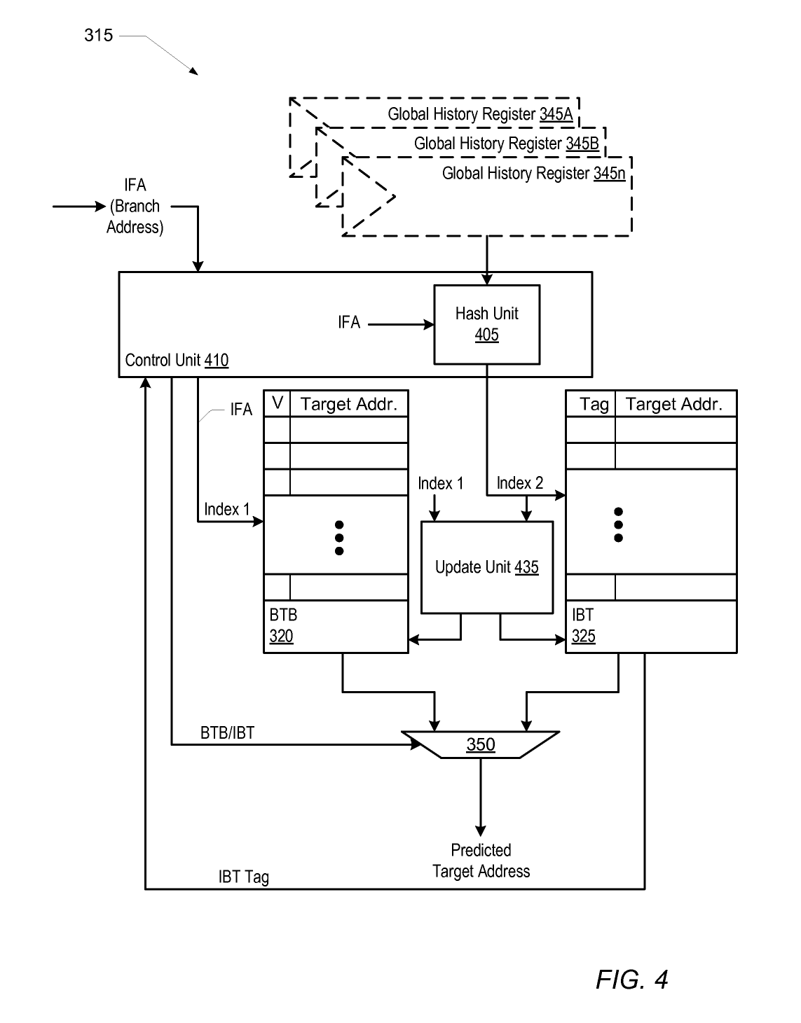

To implement branch prediction, IFU 200 may implement a variety of control and data structures in various embodiments, such as history registers that track prior branch history (shown in FIG. 3 and FIG. 4), weight tables that reflect relative weights or strengths of predictions, and/or target data structures (shown in FIG. 3 and FIG. 4) that store fetch addresses that are predicted to be targets of a CTI. Also, in some embodiments, IFU 200 may further be configured to partially decode (or predecode) fetched instructions in order to facilitate branch prediction. A predicted fetch address for a given thread may be used as the fetch address when the given thread is selected for fetching by IFU 200. The outcome of the prediction may be validated when the CTI is actually executed. If the prediction was incorrect, instructions along the predicted path that were fetched and issued may be cancelled.

Through the operations discussed above, IFU 200 may be configured to fetch and maintain a buffered pool of instructions from one or multiple threads, to be fed into the remainder of the instruction pipeline for execution. Generally speaking, select unit 210 may be configured to select and schedule threads for execution. In one embodiment, during any given execution cycle of core 100, select unit 210 may be configured to select up to one ready thread out of the maximum number of threads concurrently supported by core 100 (e.g., 8 threads), and may select up to two instructions from the selected thread for decoding by decode unit 215, although in other embodiments, a differing number of threads and instructions may be selected. In various embodiments, different conditions may affect whether a thread is ready for selection by select unit 210, such as branch mispredictions, unavailable instructions, or other conditions. To ensure fairness in thread selection, some embodiments of select unit 210 may employ arbitration among ready threads (e.g. a least-recently-used algorithm).

The particular instructions that are selected for decode by select unit 210 may be subject to the decode restrictions of decode unit 215; thus, in any given cycle, fewer than the maximum possible number of instructions may be selected. Additionally, in some embodiments, select unit 210 may be configured to allocate certain execution resources of core 100 to the selected instructions, so that the allocated resources will not be used for the benefit of another instruction until they are released. For example, select unit 210 may allocate resource tags for entries of a reorder buffer, load/store buffers, or other downstream resources that may be utilized during instruction execution.

Generally, decode unit 215 may be configured to prepare the instructions selected by select unit 210 for further processing. Decode unit 215 may be configured to identify the particular nature of an instruction (e.g., as specified by its opcode) and to determine the source and sink (i.e., destination) registers encoded in an instruction, if any. In some embodiments, decode unit 215 may be configured to detect certain dependencies among instructions, to remap architectural registers to a flat register space, and/or to convert certain complex instructions to two or more simpler instructions for execution. Additionally, in some embodiments, decode unit 215 may be configured to assign instructions to slots for subsequent scheduling. In one embodiment, two slots 0-1 may be defined, where slot 0 includes instructions executable in load/store unit 245 or execution units 235-240, and where slot 1 includes instructions executable in execution units 235-240, floating point/graphics unit 255, and any branch instructions. However, in other embodiments, other numbers of slots and types of slot assignments may be employed, or slots may be omitted entirely.

Register renaming may facilitate the elimination of certain dependencies between instructions (e.g., write-after-read or “false” dependencies), which may in turn prevent unnecessary serialization of instruction execution. In one embodiment, rename unit 220 may be configured to rename the logical (i.e., architected) destination registers specified by instructions by mapping them to a physical register space, resolving false dependencies in the process. In some embodiments, rename unit 220 may maintain mapping tables that reflect the relationship between logical registers and the physical registers to which they are mapped.

Once decoded and renamed, instructions may be ready to be scheduled for execution. In the illustrated embodiment, pick unit 225 may be configured to pick instructions that are ready for execution and send the picked instructions to issue unit 230. In one embodiment, pick unit 225 may be configured to maintain a pick queue that stores a number of decoded and renamed instructions as well as information about the relative age and status of the stored instructions. During each execution cycle, this embodiment of pick unit 225 may pick up to one instruction per slot. For example, taking instruction dependency and age information into account, for a given slot, pick unit 225 may be configured to pick the oldest instruction for the given slot that is ready to execute.

In some embodiments, pick unit 225 may be configured to support load/store speculation by retaining speculative load/store instructions (and, in some instances, their dependent instructions) after they have been picked. This may facilitate replaying of instructions in the event of load/store misspeculation. Additionally, in some embodiments, pick unit 225 may be configured to deliberately insert “holes” into the pipeline through the use of stalls, e.g., in order to manage downstream pipeline hazards such as synchronization of certain load/store or long-latency FGU instructions.

Issue unit 230 may be configured to provide instruction sources and data to the various execution units for picked instructions. In one embodiment, issue unit 230 may be configured to read source operands from the appropriate source, which may vary depending upon the state of the pipeline. For example, if a source operand depends on a prior instruction that is still in the execution pipeline, the operand may be bypassed directly from the appropriate execution unit result bus. Results may also be sourced from register files representing architectural (i.e., user-visible) as well as non-architectural state. In the illustrated embodiment, core 100 includes a working register file 260 that may be configured to store instruction results (e.g., integer results, floating point results, and/or condition code results) that have not yet been committed to architectural state, and which may serve as the source for certain operands. The various execution units may also maintain architectural integer, floating-point, and condition code state from which operands may be sourced.

Instructions issued from issue unit 230 may proceed to one or more of the illustrated execution units for execution. In one embodiment, each of EXU0 235 and EXU1 240 may be similarly or identically configured to execute certain integer-type instructions defined in the implemented ISA, such as arithmetic, logical, and shift instructions. In the illustrated embodiment, EXU0 235 may be configured to execute integer instructions issued from slot 0, and may also perform address calculation and for load/store instructions executed by LSU 245. EXU1 240 may be configured to execute integer instructions issued from slot 1, as well as branch instructions. In one embodiment, FGU instructions and multicycle integer instructions may be processed as slot 1 instructions that pass through the EXU1 240 pipeline, although some of these instructions may actually execute in other functional units.

In some embodiments, architectural and non-architectural register files may be physically implemented within or near execution units 235-240. It is contemplated that in some embodiments, core 100 may include more or fewer than two integer execution units, and the execution units may or may not be symmetric in functionality. Also, in some embodiments execution units 235-240 may not be bound to specific issue slots, or may be differently bound than just described.

Load store unit 245 may be configured to process data memory references, such as integer and floating-point load and store instructions and other types of memory reference instructions. LSU 245 may include a data cache 250 as well as logic configured to detect data cache misses and to responsively request data from L2 cache 105. In one embodiment, data cache 250 may be configured as a set-associative, write-through cache in which all stores are written to L2 cache 105 regardless of whether they hit in data cache 250. As noted above, the actual computation of addresses for load/store instructions may take place within one of the integer execution units, though in other embodiments, LSU 245 may implement dedicated address generation logic. In some embodiments, LSU 245 may implement an adaptive, history-dependent hardware prefetcher configured to predict and prefetch data that is likely to be used in the future, in order to increase the likelihood that such data will be resident in data cache 250 when it is needed.

In various embodiments, LSU 245 may implement a variety of structures configured to facilitate memory operations. For example, LSU 245 may implement a data TLB to cache virtual data address translations, as well as load and store buffers configured to store issued but not-yet-committed load and store instructions for the purposes of coherency snooping and dependency checking. LSU 245 may include a miss buffer configured to store outstanding loads and stores that cannot yet complete, for example due to cache misses. In one embodiment, LSU 245 may implement a store queue configured to store address and data information for stores that have committed, in order to facilitate load dependency checking. LSU 245 may also include hardware configured to support atomic load-store instructions, memory-related exception detection, and read and write access to special-purpose registers (e.g., control registers).

Floating point/graphics unit 255 may be configured to execute and provide results for certain floating-point and graphics-oriented instructions defined in the implemented ISA. For example, in one embodiment FGU 255 may implement single- and double-precision floating-point arithmetic instructions compliant with the IEEE 754-1985 floating-point standard, such as add, subtract, multiply, divide, and certain transcendental functions. Also, in one embodiment FGU 255 may implement partitioned-arithmetic and graphics-oriented instructions defined by a version of the SPARC® Visual Instruction Set (VIS™) architecture, such as VIS™ 2.0 or VIS™ 3.0. In some embodiments, FGU 255 may implement fused and unfused floating-point multiply-add instructions. Additionally, in one embodiment FGU 255 may implement certain integer instructions such as integer multiply, divide, and population count instructions. Depending on the implementation of FGU 255, some instructions (e.g., some transcendental or extended-precision instructions) or instruction operand or result scenarios (e.g., certain denormal operands or expected results) may be trapped and handled or emulated by software.

In one embodiment, FGU 255 may implement separate execution pipelines for floating point add/multiply, divide/square root, and graphics operations, while in other embodiments the instructions implemented by FGU 255 may be differently partitioned. In various embodiments, instructions implemented by FGU 255 may be fully pipelined (i.e., FGU 255 may be capable of starting one new instruction per execution cycle), partially pipelined, or may block issue until complete, depending on the instruction type. For example, in one embodiment floating-point add and multiply operations may be fully pipelined, while floating-point divide operations may block other divide/square root operations until completed.

Embodiments of FGU 255 may also be configured to implement hardware cryptographic support. For example, FGU 255 may include logic configured to support encryption/decryption algorithms such as Advanced Encryption Standard (AES), Data Encryption Standard/Triple Data Encryption Standard (DES/3DES), the Kasumi block cipher algorithm, and/or the Camellia block cipher algorithm. FGU 255 may also include logic to implement hash or checksum algorithms such as Secure Hash Algorithm (SHA-1, SHA-256, SHA-384, SHA-512), or Message Digest 5 (MD5). FGU 255 may also be configured to implement modular arithmetic such as modular multiplication, reduction and exponentiation, as well as various types of Galois field operations. In one embodiment, FGU 255 may be configured to utilize the floating-point multiplier array for modular multiplication. In various embodiments, FGU 255 may implement several of the aforementioned algorithms as well as other algorithms not specifically described.

The various cryptographic and modular arithmetic operations provided by FGU 255 may be invoked in different ways for different embodiments. In one embodiment, these features may be implemented via a discrete coprocessor that may be indirectly programmed by software, for example by using a control word queue defined through the use of special registers or memory-mapped registers. In another embodiment, the ISA may be augmented with specific instructions that may allow software to directly perform these operations.

As previously described, instruction and data memory accesses may involve translating virtual addresses to physical addresses. In one embodiment, such translation may occur on a page level of granularity, where a certain number of address bits comprise an offset into a given page of addresses, and the remaining address bits comprise a page number. For example, in an embodiment employing 4 MB pages, a 64-bit virtual address and a 40-bit physical address, 22 address bits (corresponding to 4 MB of address space, and typically the least significant address bits) may constitute the page offset. The remaining 42 bits of the virtual address may correspond to the virtual page number of that address, and the remaining 18 bits of the physical address may correspond to the physical page number of that address. In such an embodiment, virtual to physical address translation may occur by mapping a virtual page number to a particular physical page number, leaving the page offset unmodified.

Such translation mappings may be stored in an ITLB or a DTLB for rapid translation of virtual addresses during lookup of instruction cache 205 or data cache 250. In the event no translation for a given virtual page number is found in the appropriate TLB, memory management unit 270 may be configured to provide a translation. In one embodiment, MMU 270 may be configured to manage one or more translation tables stored in system memory and to traverse such tables (which in some embodiments may be hierarchically organized) in response to a request for an address translation, such as from an ITLB or DTLB miss. (Such a traversal may also be referred to as a page table walk or a hardware table walk.) In some embodiments, if MMU 270 is unable to derive a valid address translation, for example if one of the memory pages including a necessary page table is not resident in physical memory (i.e., a page miss), MMU 270 may be configured to generate a trap to allow a memory management software routine to handle the translation. It is contemplated that in various embodiments, any desirable page size may be employed. Further, in some embodiments multiple page sizes may be concurrently supported.

As noted above, several functional units in the illustrated embodiment of core 100 may be configured to generate off-core memory requests. For example, IFU 200 and LSU 245 each may generate access requests to L2 cache 105 in response to their respective cache misses. Additionally, MMU 270 may be configured to generate memory requests, for example while executing a page table walk. In the illustrated embodiment, L2 interface 265 may be configured to provide a centralized interface to the L2 cache 105 associated with a particular core 100, on behalf of the various functional units that may generate L2 accesses. In one embodiment, L2 interface 265 may be configured to maintain queues of pending L2 requests and to arbitrate among pending requests to determine which request or requests may be conveyed to L2 cache 105 during a given execution cycle. For example, L2 interface 265 may implement a least-recently-used or other algorithm to arbitrate among L2 requestors. In one embodiment, L2 interface 265 may also be configured to receive data returned from L2 cache 105, and to direct such data to the appropriate functional unit (e.g., to data cache 250 for a data cache fill due to miss).

During the course of operation of some embodiments of core 100, exceptional events may occur. For example, an instruction from a given thread that is selected for execution by select unit 210 may not be a valid instruction for the ISA implemented by core 100 (e.g., the instruction may have an illegal opcode), a floating-point instruction may produce a result that requires further processing in software, MMU 270 may not be able to complete a page table walk due to a page miss, a hardware error (such as uncorrectable data corruption in a cache or register file) may be detected, or any of numerous other possible architecturally-defined or implementation-specific exceptional events may occur. In one embodiment, trap logic unit 275 may be configured to manage the handling of such events. For example, TLU 275 may be configured to receive notification of an exceptional event occurring during execution of a particular thread, and to cause execution control of that thread to vector to a supervisor-mode software handler (i.e., a trap handler) corresponding to the detected event. Such handlers may include, for example, an illegal opcode trap handler configured to return an error status indication to an application associated with the trapping thread and possibly terminate the application, a floating-point trap handler configured to fix up an inexact result, etc.

In one embodiment, TLU 275 may be configured to flush all instructions from the trapping thread from any stage of processing within core 100, without disrupting the execution of other, non-trapping threads. In some embodiments, when a specific instruction from a given thread causes a trap (as opposed to a trap-causing condition independent of instruction execution, such as a hardware interrupt request), TLU 275 may implement such traps as precise traps. That is, TLU 275 may ensure that all instructions from the given thread that occur before the trapping instruction (in program order) complete and update architectural state, while no instructions from the given thread that occur after the trapping instruction (in program) order complete or update architectural state.

Additionally, in the absence of exceptions or trap requests, TLU 275 may be configured to initiate and monitor the commitment of working results to architectural state. For example, TLU 275 may include a reorder buffer (ROB) that coordinates transfer of speculative results into architectural state. TLU 275 may also be configured to coordinate thread flushing that results from branch misprediction. For instructions that are not flushed or otherwise cancelled due to mispredictions or exceptions, instruction processing may end when instruction results have been committed.

In various embodiments, any of the units illustrated in FIG. 2 may be implemented as one or more pipeline stages, to form an instruction execution pipeline that begins when thread fetching occurs in IFU 200 and ends with result commitment by TLU 275. Depending on the manner in which the functionality of the various units of FIG. 2 is partitioned and implemented, different units may require different numbers of cycles to complete their portion of instruction processing. In some instances, certain units (e.g., FGU 255) may require a variable number of cycles to complete certain types of operations.

Through the use of dynamic multithreading, in some instances, it is possible for each stage of the instruction pipeline of core 100 to hold an instruction from a different thread in a different stage of execution, in contrast to conventional processor implementations that typically require a pipeline flush when switching between threads or processes. In some embodiments, flushes and stalls due to resource conflicts or other scheduling hazards may cause some pipeline stages to have no instruction during a given cycle. However, in the fine-grained multithreaded processor implementation employed by the illustrated embodiment of core 100, such flushes and stalls may be directed to a single thread in the pipeline, leaving other threads undisturbed. Additionally, even if one thread being processed by core 100 stalls for a significant length of time (for example, due to an L2 cache miss), instructions from another thread may be readily selected for issue, thus increasing overall thread processing throughput.

As described previously, however, the various resources of core 100 that support fine-grained multithreaded execution may also be dynamically reallocated to improve the performance of workloads having fewer numbers of threads. Under these circumstances, some threads may be allocated a larger share of execution resources while other threads are allocated correspondingly fewer resources. Even when fewer threads are sharing comparatively larger shares of execution resources, however, core 100 may still exhibit the flexible, thread-specific flush and stall behavior described above.

Turning now to FIG. 3, an architectural block diagram illustrating more detailed aspects of the IFU 200 are shown. More particularly, in the embodiment shown in FIG. 3, the IFU 200 includes an instruction cache 205 which is coupled to a multiplexer 360, which is coupled to a next fetch address register 335. The IFU 200 also includes branch prediction unit (BPU) 300, which is also coupled to the multiplexer 360 and to the next fetch address register 335.

In the illustrated embodiment, the BPU 300 includes a direction branch prediction unit 310, which includes a global history register (GHR) 345, and a target branch prediction unit 315, which includes a branch target buffer (BTB) 320 and an indirect branch table (IBT) 325. The BTB 320 and the IBT 325 are both coupled to a multiplexer 350, which is in turn coupled to the multiplexer 360.

As described above, the IFU 200 may implement history registers that track prior branch direction history. Accordingly, in FIG. 3, GHR 345 may store branch history information on a per thread basis and in one embodiment GHR 345 may provide separate global history storage for each thread. In one embodiment, GHR 345 may store branch direction history (e.g., taken/not taken history) for each thread. Accordingly, GHR 345 may be implemented as multiple multi-bit shift registers, (one for each thread) in which a one or a zero is shifted in for each conditional branch instruction executed. In one embodiment, if the branch is taken a one may be shifted in, and if the branch is not taken, a zero may be shifted in. However, it is contemplated that in other embodiments a zero may be representative of a taken branch and a one may be representative of a not taken branch. In one embodiment, if a branch is mis-predicted, the appropriate shift register of GHR 345 may be updated with the actual taken/not taken result.

In one embodiment, the BTB 320 includes a number of entries, each of which may be configured to store a valid bit and a target address of a previously executed indirect branch instruction. Thus, this target address may be referred to as a predicted target address for a next branch instruction corresponding to the same IFA. The IBT 325 may also include a number of entries, each of which may be configured to store a tag and a target address of a previously executed indirect branch instruction. As described further below, some number of bits of the instruction fetch address (IFA) may be used to form an index to access the BTB 320. However, since targets of an indirect branch correlate to prior global direction branch history, as described further below, in one embodiment the index used to access the IBT 325 may be a hash of some number of bits of the IFA and some number of bits of the global branch history from GHR 345 for the executing thread.

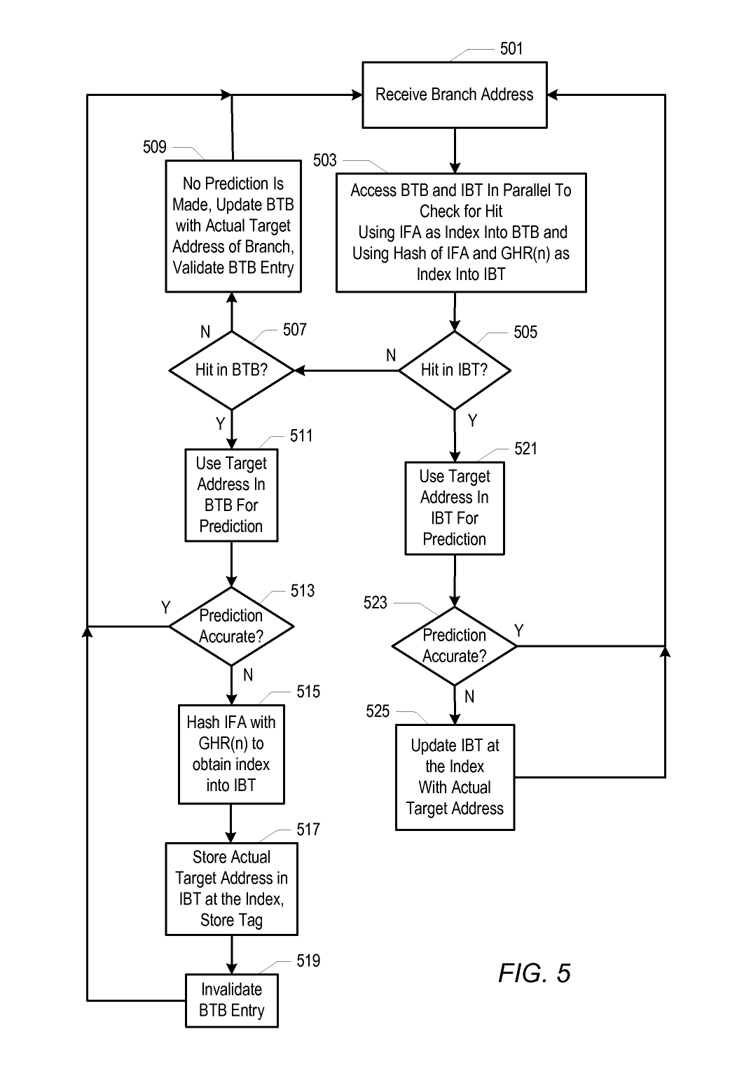

Accordingly, when an IFA is received, it may be presented to the instruction cache 205, and the branch prediction unit 300. Depending on the type of branch instruction, the address of the branch may be predicted (e.g., for an indirect branch) or obtained from information stored in the instruction cache 205 (e.g., for a PC relative branch). Control signals may select the source of the branch target address based upon the above considerations. As described in greater detail below in conjunction with the descriptions of FIG. 4 and FIG. 5, if the instruction is an indirect branch instruction, the branch target address may be provided by one of the BTB 320 or the IBT 325.

Referring to FIG. 4, a block diagram of one embodiment of the target branch prediction (TBP) unit 315 is shown. It is noted that components that correspond to those shown in FIG. 3 are numbered identically for clarity and simplicity. The TBP unit 315 includes a control unit 410 that is coupled to a branch target buffer (BTB) 320 and to an indirect branch table (IBT) 325. The TBP unit 315 also includes an update unit 435 that is coupled to the BTB 320 and the IBT 325. The control unit includes a hash unit 405 that is coupled to the IBT 325 and to global history registers 345A through 345n, where n may be any number. The BTB 320 and the IBT 325 are coupled to a mux 350. The mux control input (BTB/IBT) is also coupled to the control unit 410.

In the illustrated embodiment, the BTB 320 includes a number of entries. Each entry may store a target address corresponding to the IFA, and a valid bit. In one embodiment, the BTB 320 may be implemented as a direct mapped array. As shown, to access the BTB 320 a read address may be formed by generating an index (e.g., Index 1). In one embodiment, the Index 1 may include some number of bits of the IFA, which is provided by the control unit 410. The valid bit may be used as a hit indication, when it is asserted. For example, in one specific implementation the array may include 128 entries. Accordingly, Index 1 may include seven bits of the IFA. In various embodiments, the seven bits may be a group of seven contiguous bits of the IFA, or the Index 1 may be seven bits resulting from a hash of various IFA bits.

The IBT 325 also includes a number of entries, and may also be implemented as a direct mapped array in one embodiment. As shown, each entry in the IBT 325 may store a target address and corresponding tag. In one embodiment, the tag may include some number of bits of the IFA. Similar to the BTB, a read address may be formed by generating an index (e.g., Index 2). In one embodiment, the IBT 325 may also include 128 entries, and as such Index 2 may include seven bits. In one implementation, hash unit 405 may generate Index 2 by performing a hash of global branch history bits from GHR 345 and the IFA. Thus, the target addresses stored within the IBT 325 may be correlated to not only the IFA but also global branch direction history information (e.g., taken/not taken) corresponding to the IFA.

In one embodiment, each of the BTB 320 and the IBT 325 may provide a plurality of predictions on each access. For example, in one embodiment, the BTB 320 and IBT 325 may provide four or more predictions for four instructions being fetched from the instruction cache each cycle. As such, each of the BTB 320 and the IBT 325 may be implemented to have four sets of 128 entries.

As described above, the control unit 410 receives the IFA and provides some number of bits of the IFA to the BTB 320 as Index 1, and some number of bits of the IFA to hash unit 405. The control unit 410 also receives tag information from the IBT 325, which may be used to determine whether there is a hit in the IBT 325 and to select which of the BTB 320 and IBT 325 target addresses to output from the mux 350 as the predicted target address for a given IFA.

As mentioned above, the global history registers 345 may store global branch history information on a per thread basis. In one embodiment, each of GHR 345A-345n may correspond to a respective or different thread. In addition, in one embodiment, each GHR 345 may store branch direction information (e.g., taken/not taken) in the form of a number of ones and zeros. For example, as described above each GHR 345 may be a shift register which holds a number of bits and each bit may be an indication of a prior conditional branch taken or not taken. Each time a conditional branch instruction is executed, the actual direction of the branch may be compared with the predicted direction and if there is a mispredict, the appropriate GHR 345 may be updated by logic (not shown) in the IFU 200.

In one embodiment, the hash unit 405 may perform a hash function using a number of address bits (e.g., seven) of the IFA and a number of bits (e.g., seven) of the GHR 345 that corresponds to the executing thread. In one implementation, the hash function may be a bit-wise Exclusive-Or (XOR) function, where each bit of the selected IFA bits is XOR'd with a corresponding bit of the selected GHR 345 bits. However, it is noted that other hash functions are possible and contemplated.

In one embodiment, the update unit 435 may store the index values for each incoming IFA, as well as the predicted target address. As described further below, upon execution of the branch instruction, the predicted target address may be compared with the actual target address, and if there is a mispredict, the update unit 435 may either update the target address in the IBT 325 or move the prediction from the BTB 320 into the IBT 325 as necessary, depending on which was used. In one embodiment, the write address to write into the BTB 320 may be formed using Index 1, and the write address to update the IBT 325 may be formed using Index 2.

In one embodiment, in response to an IFA of an indirect branch being received by the control unit 410, the BTB 320 and the IBT 325 may be accessed substantially simultaneously to determine if a predicted target address is available. As described in greater detail below in conjunction with the description of FIG. 5, if there is a hit in the BTB 320 and not in the IBT 320, and the prediction is accurate, the BTB 320 may be used for subsequent predictions for that IFA. However, if the prediction is not accurate, then the prediction for that IFA may be moved to the IBT 325, and the entry in the BTB 320 may be invalidated. In the event that there is a hit in both, in one embodiment the target address in IBT 325 may be preferentially selected. Thus, for indirect branch instructions in which the target address does not change, the BTB 320 may provide adequate predictions. However, for indirect branch instructions in which the target address may be dynamically changed by software, for example, the IBT 325 may provide more accurate predictions. Accordingly, the IBT 325 may be referred to as a primary storage, and the BTB 320 may be referred to as a secondary storage.

Turning to FIG. 5, a flow diagram depicting operational aspects of the target branch prediction unit of FIG. 3 and FIG. 4 is shown. Referring collectively to FIG. 3 through FIG. 5 and beginning in block 501 of FIG. 5, where an IFA of an indirect branch is received by the control unit 410 of the BPU 315. The control unit 410 generates the read address for the BTB 320 by forming Index 1 using some number of bits if the IFA as described above. In addition, the control unit 410 generates the read address for the IBT 325 by providing the IFA and the information from the GHR 345 to the hash unit 405 to generate Index 2. The BTB 320 and the IBT 325 may be accessed in parallel to check for a corresponding entry (block 503). As described above, the tags stored in the IBT 325 may be used by the control unit 410 to determine whether there is a hit in the IBT 325, and the valid bits may be used to determine whether there is a hit in the BTB 320.

If there is no hit in the IBT 325 (block 505), and there is no hit in the BTB 320 (block 507), then no prediction is made. When the branch is executed, the actual branch address may be written to the entry of the BTB 320 that corresponds to the Index 1 value, and the valid bit for that entry may be asserted (block 509). However, referring back to block 507, if there is a hit in the BTB 320, the target address may be read out of the entry in BTB 320 indexed by Index 1 and the control unit 410 may select the BTB 320 output at mux 350.

Once the execution unit executes the branch instruction, the actual branch address may be compared to the predicted target address to determine if the prediction was accurate (block 513). If the prediction is accurate, the BPU 315 awaits the next branch instruction IFA as described above in conjunction with block 501.

However, if the prediction is not accurate (block 513), it is assumed that the target has changed. Thus, the control unit 410 is configured to move the prediction to the IBT 325. Accordingly, the control unit 410 forms the write address in the IBT 325 by providing the IFA of the mispredicted branch instruction to the hash unit 405. The hash unit 405 generates Index 2 by hashing the GHR 345 information with the IFA as described above (block 515). The control unit 410 causes the update unit 435 to write the actual target address and the corresponding tag into the entry of the IBT 325 identified by the Index 2 value (block 517). In addition, the control unit 410 invalidates the entry in the BTB 320 (e.g., by deasserting the valid bit for that entry) that had the mispredicted entry (block 519). Operation then proceeds as described above in conjunction with block 501.

Referring back to block 505, if there is a hit in the IBT 325, the target address in the entry may be read out of the IBT 325 and the control unit 410 may select the IBT 325 output at mux 350 (block 521). Once the execution unit executes the branch instruction, the actual branch address may be compared to the predicted target address to determine if the prediction was accurate (block 523). If the prediction is accurate, the BPU 315 awaits the next branch instruction IFA as described above in conjunction with block 501.

However, if the prediction is not accurate (block 523), the control unit 410 is configured to cause the update unit 435 to update the target address in the IBT 325. More particularly, the update unit 435 may use the Index 2 as the write address into the IBT 325 entry from which the prediction was made, and then write the actual target address into that entry (block 525). Operation then proceeds as described above in conjunction with block 501.

It is noted that the BTB 320 and the IBT 325 may be shared across all threads. However, as mentioned above, since each of GHR 345A-345n may be thread specific, each branch prediction in the IBT 325 may be correlated to the branch direction history of the particular thread that is executing.

### Exemplary System Embodiment

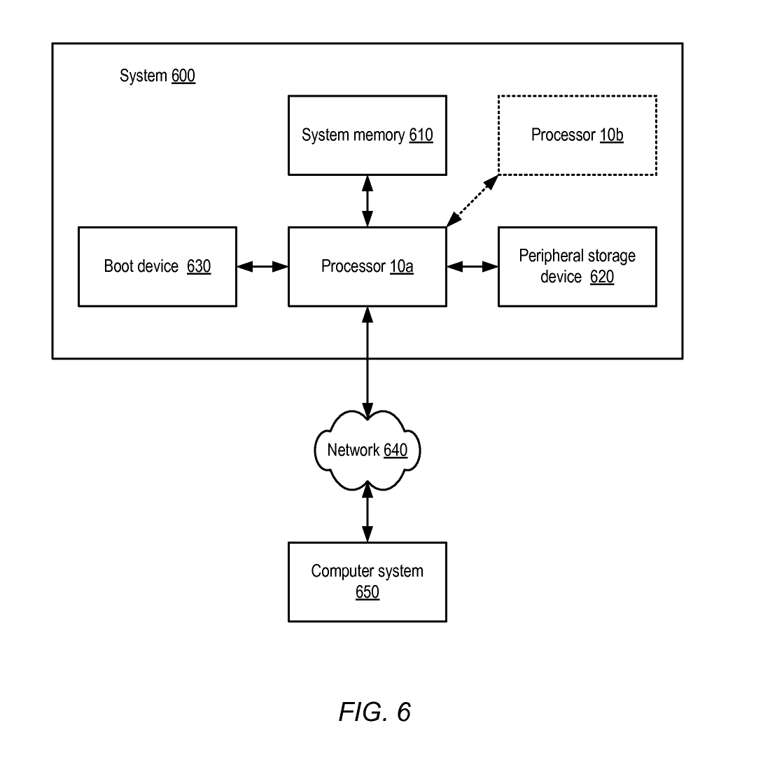

As described above, in some embodiments, processor 10 of FIG. 1 may be configured to interface with a number of external devices. One embodiment of a system including processor 10 is illustrated in FIG. 6. In the illustrated embodiment, system 600 includes an instance of processor 10, shown as processor 10a, that is coupled to a system memory 610, a peripheral storage device 620 and a boot device 630. System 600 is coupled to a network 640, which is in turn coupled to another computer system 650. In some embodiments, system 600 may include more than one instance of the devices shown. In various embodiments, system 600 may be configured as a rack-mountable server system, a standalone system, or in any other suitable form factor. In some embodiments, system 600 may be configured as a client system rather than a server system.

In some embodiments, system 600 may be configured as a multiprocessor system, in which processor 10a may optionally be coupled to one or more other instances of processor 10, shown in FIG. 6 as processor 10b. For example, processors 10a-b may be coupled to communicate via their respective coherent processor interfaces 140.

In various embodiments, system memory 610 may comprise any suitable type of system memory as described above, such as FB-DIMM, DDR/DDR2/DDR3/DDR4 SDRAM, or RDRAM®, for example. System memory 610 may include multiple discrete banks of memory controlled by discrete memory interfaces in embodiments of processor 10 that provide multiple memory interfaces 130. Also, in some embodiments, system memory 610 may include multiple different types of memory.

Peripheral storage device 620, in various embodiments, may include support for magnetic, optical, or solid-state storage media such as hard drives, optical disks, nonvolatile RAM devices, etc. In some embodiments, peripheral storage device 620 may include more complex storage devices such as disk arrays or storage area networks (SANs), which may be coupled to processor 10 via a standard Small Computer System Interface (SCSI), a Fibre Channel interface, a Firewire® (IEEE 1394) interface, or another suitable interface. Additionally, it is contemplated that in other embodiments, any other suitable peripheral devices may be coupled to processor 10, such as multimedia devices, graphics/display devices, standard input/output devices, etc. In one embodiment, peripheral storage device 620 may be coupled to processor 10 via peripheral interface(s) 150 of FIG. 1.

As described previously, in one embodiment boot device 630 may include a device such as an FPGA or ASIC configured to coordinate initialization and boot of processor 10, such as from a power-on reset state. Additionally, in some embodiments boot device 630 may include a secondary computer system configured to allow access to administrative functions such as debug or test modes of processor 10.

Network 640 may include any suitable devices, media and/or protocol for interconnecting computer systems, such as wired or wireless Ethernet, for example. In various embodiments, network 640 may include local area networks (LANs), wide area networks (WANs), telecommunication networks, or other suitable types of networks. In some embodiments, computer system 650 may be similar to or identical in configuration to illustrated system 600, whereas in other embodiments, computer system 650 may be substantially differently configured. For example, computer system 650 may be a server system, a processor-based client system, a stateless “thin” client system, a mobile device, etc. In some embodiments, processor 10 may be configured to communicate with network 640 via network interface(s) 160 of FIG. 1.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A multithreaded microprocessor comprising:
an instruction fetch unit configured to fetch and maintain a plurality of instructions belonging to one or more threads; and
one or more execution units configured to concurrently execute the one or more threads;
wherein the instruction fetch unit includes a target branch prediction unit configured to provide a predicted branch target address in response to receiving an instruction fetch address of a current indirect branch instruction, wherein the branch prediction unit includes:
a primary storage including a plurality of entries, wherein each entry is configured to store a predicted branch target address corresponding to a previous indirect branch instruction; and
a control unit coupled to the storage and configured to generate an index value for accessing the primary storage using a portion of the instruction fetch address of the current indirect branch instruction, and branch direction history information associated with a currently executing thread of the one or more threads.

2. The processor as recited in claim 1, wherein the target branch prediction unit further includes a secondary storage including a second plurality of entries, wherein each entry of the secondary storage is configured to store another predicted branch target address corresponding to another previous indirect branch instruction.

3. The processor as recited in claim 2, wherein the control unit is configured to generate a second index for accessing the secondary storage using a second portion of the instruction fetch address of the current indirect branch instruction.

4. The processor as recited in claim 2, wherein the control unit is configured to access the primary storage and the secondary storage substantially simultaneously.

5. The processor as recited in claim 2, wherein the control unit is further configured to select the predicted branch target address from the primary storage in response to detecting a hit indication from the primary storage irrespective of whether a hit is detected in the secondary storage.

6. The processor as recited in claim 1, wherein the control unit includes a hash unit configured to generate the index value by performing a hash operation on the portion of the instruction fetch address of the current indirect branch instruction and the branch direction history information.

7. The processor as recited in claim 6, wherein the branch direction history information includes a plurality of bits, each bit indicating a taken or not taken direction of a previously executed conditional branch instruction associated with the currently executing thread.

8. The processor as recited in claim 7, wherein the hash operation comprises a bit-wise Exclusive-OR operation between each bit of the portion of the instruction fetch address and a respective bit of the plurality of bits of the branch direction history information.

9. The processor as recited in claim 6, wherein the branch prediction unit further includes a plurality of global branch history storages, each configured to store the plurality of bits corresponding to the branch direction history information for a respective thread of the one or more threads.

10. A method comprising:
an instruction fetch unit fetching a plurality of instructions belonging to one or more threads; and
one or more execution units concurrently executing the one or more threads;
wherein a target branch prediction unit within the instruction fetch unit providing a predicted branch target address in response to receiving an instruction fetch address of a current indirect branch instruction:
the target branch prediction unit storing within each entry of a primary storage a predicted branch target address corresponding to a previous indirect branch instruction; and
a control unit of the target branch prediction unit generating an index value for accessing the primary storage using a portion of the instruction fetch address of the current indirect branch instruction, and branch direction history information associated with a currently executing thread of the one or more threads.

11. The method as recited in claim 10, further comprising the target branch prediction unit storing within an entry of a secondary storage, another predicted branch target address corresponding to another previous indirect branch instruction.

12. The method as recited in claim 11, further comprising the control unit generating a second index for accessing the secondary storage using a second portion of the instruction fetch address of the current indirect branch instruction.

13. The method as recited in claim 11, further comprising the control unit accessing the primary storage and the secondary storage substantially simultaneously.

14. The method as recited in claim 11, further comprising the control unit preferentially selecting the predicted branch target address from the primary storage in response to detecting a hit indication from the primary storage.

15. The method as recited in claim 11, further comprising the control unit generating the index value by performing a hash operation on the portion of the instruction fetch address of the current indirect branch instruction and the branch direction history information.

16. The method as recited in claim 15, wherein the branch direction history information includes a plurality of bits, each bit indicating a taken or not taken direction of a previously executed conditional branch instruction associated with the currently executing thread.

17. The method as recited in claim 16, further comprising the one or more threads sharing the primary storage and the secondary storage, and the target branch prediction unit storing the plurality of bits corresponding to the branch direction history information for a respective thread of the one or more threads within a respective global branch direction history storage.

18. A system comprising:
a multithreaded processor including a plurality of multithreaded processor cores, wherein each multithreaded processor core includes:
an instruction fetch unit configured to fetch and maintain a plurality of instructions belonging to one or more threads; and
one or more execution units configured to concurrently execute the one or more threads;
wherein the instruction fetch unit includes a target branch prediction unit configured to provide a predicted branch target address in response to receiving an instruction fetch address of a current indirect branch instruction, wherein the branch prediction unit includes:
a primary storage including a plurality of entries, wherein each entry is configured to store a predicted branch target address corresponding to a previous indirect branch instruction; and
a control unit coupled to the primary storage and configured to generate an index value for accessing the primary storage using a portion of the instruction fetch address of the current indirect branch instruction, and branch direction history information associated with a currently executing thread of the one or more threads.

19. The system as recited in claim 18, wherein the target branch prediction unit further includes a secondary storage including a second plurality of entries, wherein each entry of the secondary storage is configured to store another predicted branch target address corresponding to another previous indirect branch instruction.

20. The processor as recited in claim 19, wherein the control unit is configured to generate a second index for accessing the storage using a second portion of the instruction fetch address of the current indirect branch instruction.
